(19) United States
(12) Patent Application Publication
(10) Pub. No.: US 2009/0091617 A1
(43) Pub. Date: Apr. 9, 2009

(54) ELECTRONIC BABY REMOTE VIEWER

(76) Inventor: LEROY E. ANDERSON, BOISE, ID (US)

Correspondence Address: DYKAS, SHAVER & NIPPER, LLP, P.O. BOX 877, BOISE, ID, 83701-0877, US

(21) Appl. No.: 12/245,933

(22) Filed: Oct. 6, 2008

Related U.S. Application Data
(60) Provisional application No. 60/977,790, filed on Oct. 5, 2007.

(51) Int. Cl. H04N 7/18; H04N 5/262

(52) U.S. Cl. 348/143; 348/240.99; 348/E07.085; 348/E05.055

(57) ABSTRACT

The invention is an electronic remote baby viewer for placement near a baby or child, so that a person interested in monitoring the baby can view the baby from another room of a house, or from outside the house. The unit includes a zoom function which zooms to the lower center, to the right, left, lower left, or lower right of the screen in order to give the user a view of those regions in order to better see a baby. The unit can be mounted crib side, or in a position to view a baby in a car seat in an automobile.

### CROSS-REFERENCE TO RELATED APPLICATIONS

This application claims the priority date of the provisional application entitled ELECTRONIC BABY REMOTE VIEWER filed by Leroy E. Anderson on Oct. 5, 2007 with application Ser. No. 60/977,790.

### FIELD OF THE INVENTION

The invention generally relates to an apparatus for viewing a child or baby and more particularly an electronic monitor for viewing a baby remotely.

### BACKGROUND OF THE INVENTION

There are many times when a parent would like to be able to visually monitor a baby from a remote location. This could be when the baby is in a crib taking a nap and the parent wants to be in the kitchen, or another room of the house, or outside of the house. Ideally the parent would like to be able to be reassured that the baby is fine by being able to see and hear the baby. There are remote monitors which allow a parent to hear a baby, but there are no monitors which allow a parent to view a baby while a parent is another room of the house. Preferably such a device would have a viewing screen which is portable and could be carried to any location so that the parent could view the child from outside the house, from the garage, or from any location within range of the device. Another situation in which a parent would like to see a baby in which it is difficult to see the baby is when the baby is in an infant car seat in the back seat of a car with the car seat facing backwards. In such a case the parent cannot see the baby's face, but many times would like to. In either of these situations and in other child monitoring situations, a digital viewer which can be seen from a location remote from the digital camera would be a benefit to parents.

### SUMMARY OF THE INVENTION

The invention is a baby remote viewer which includes a digital camera lens, a digital viewing screen, a zoom feature, a zoom activation button. The digital camera lens is configured for mounting into a position adjacent to a region to be viewed, with the region to be viewed located at some distance remote from the user of the electronic baby remote viewer. Region to be viewed could be an infant's crib in a bedroom, or it could be a car seat mounted into the rear seat of a car. Other possible regions for viewing would include the jump seat of a station wagon in which a child might be sitting, the parent's back yard in which the child might playing, the parents driveway in which the child might be playing, or other situations where the parent may wish to monitor the activities of a child.

The digital camera is in a unit which is separate from the digital viewing screen, and the digital viewing screen is configured to be portable so that a parent may take it to any location and be able to monitor the child from that location. The location could be another location in the house, it could be out doors while the child is in doors, could be in doors while a child is out doors, it could on the dash board of a car when the child is in the rear seat of the car, especially when the child is facing backwards. The digital viewing screen is configured for mounting at some distance from the digital camera lens, and is electrically connected to the digital camera lens either by wireless or by wired configuration. The digital viewing screen is positioned in a convenient position for the user of the electronic baby remote viewer to view an image on the digital viewing screen.

The baby remote viewer includes a zoom feature that selects a region in the displayed image for magnification, with that region being a region other than the center of the image. The typical zoom lens zooms towards the center of the image and makes the center of an image larger. The zoom feature of this device zooms to a region that is not the center of the picture, and that, in one version, can be selectable by the user. For instance, the viewer may be configured to zoom to the lower center of the image. This kind of zoom would be useful if the electronic baby remote viewer is positioned at the rear of an automobile, and the digital camera lens was directed in the general direction of the crib. Zooming to the center bottom of the image would allow the user to get a better view of the child in the crib or to the left or right side of the crib.

A zoom activation button is included that can take a number of different forms which will be discussed below. An image which is viewed in the digital viewing screen is magnified when the zoom activation button is activated and the image is magnified to show greater detail in that part of the image which is selected.

A preferred version of the device is configured specifically to zoom in on the lower center of the displayed image. The zoom feature can be based on optics in the digital camera lens and also can be based on software enhancement of the image by digital manipulation. The zoom feature can also be specifically configured to zoom in on the lower right region of the image, or the lower left region of the image. The device can also be configured with the capacity to zoom in on more than one region of the image, with the selection of the region for zooming in being left to the user's control. In such a case, a zone selection button would be provided, which would allow the region of the image selected for magnification to be identified by the user. The zone selection button can be in the form of a touch screen button, such as allowing the user to merely touch the lower center, lower right, lower left, upper center, upper right, upper left at his discretion, with the resulting magnification of that region of the image. The zone selection button can also take the form of a button which is activated repeatedly, and the selection area cycled through the different options of regions for magnification until the user selects which view he would like to have magnified. The selection of a zone for magnification could also be accomplished by use of a touch screen display.

The electronic baby remote viewer can also have a magnification button, with which the user selects from a number of different levels of magnification. The electronic baby remote viewer can also have a brightness button to allow the user to adjust the brightness of the image to a preferred level of brightness.

The electronic baby remote viewer can be used in multiples, such as with a number of digital camera lenses placed at various locations around a house, with all of them viewable on one or more digital viewing screen(s). A camera selection button would be provided in this instance to provide a way for the user to select the image and camera that are displayed on the monitor. This version of the electronic baby remote viewer would have a selection means to select a region on each image of each camera for viewing and magnification of the selected region. A magnification selection means would be provided for different levels of magnification for any of the images for any of the cameras of this version of the device. When used for security reasons, a motion detector could be used to turn the camera(s) on, or a switch on the monitor or a combination of both. A memory program may be added to the cameras so an individual may come later and play back what the camera has seen, with magnification available for the views recorded. A speaker and a microphone can be added to the camera unit so a person can carry on a conversation between the monitor and the camera unit so that somebody in the house can control a gate like a sentry unit. The camera could be used with a motion sensor so motion would also activate an alarm in the home and the monitor.

Another version of the electronic baby remote viewer includes a night light camera, which is a camera that is adjusted to provide visibility in low light situations. This camera could be used in an area where a baby is sleeping, or in the vehicle application, or in a darkened or semi-darkened doorway.

Another version of the electronic baby remote viewer is one in which the digital camera lens is mounted on the interior of a car and is positioned so as to be able to view a baby that is buckled into a car seat and facing backward, while the car seat is secured in the rear seat of the vehicle. The zoom feature would be available in this version of the viewer in position to zoom in on the baby's face. For this to happen, the camera would be adjusted so that the baby's face was in some portion of the image other than the center of the image. Other zoom regions would allow the user to view children in the backseats.

The electronic baby remote viewer of the invention can be configured to operate with battery power or ac power, with rechargeable batteries, 12 Volt DC, run off a car cigarette lighter or any combination of those electrical sources.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view of the electronic baby remote viewer of the invention.

FIG. 2 is a side view of the electronic baby remote viewer 10 of the invention mounted in an automobile.

FIG. 3 is a top view of the electronic baby remote viewer 10 of the invention mounted with a view of a backwards facing car seat.

FIG. 4 of the invention is a front view showing an image in the lower center of the display screen 14.

FIG. 5 is a front view of the image of FIG. 4 when the off center zoom feature is activated.

FIG. 6 is a front view of the unit mounted in an automobile.

### DESCRIPTION OF THE PREFERRED EMBODIMENTS

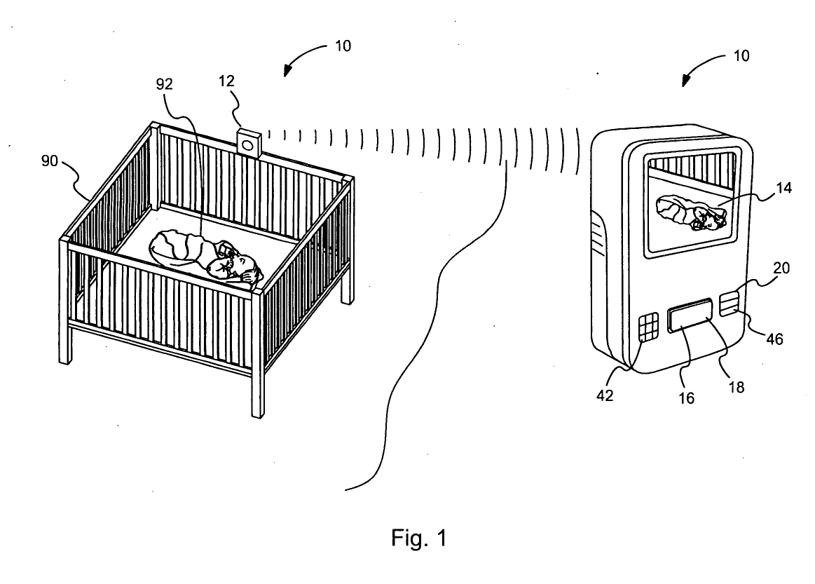

The electronic baby remote viewer of the invention is shown in FIGS. 1 through 5.

FIG. 1 is a drawing showing the electronic baby remote viewer 10 of the invention with the digital viewing screen 14 located in a location distant from the digital camera lens unit 12. In this case the digital camera lens unit 12 is positioned on a crib 90 in which a baby 92 is positioned. By utilizing the zoom point selection pad 42 on the digital viewing screen unit 14 the digital camera lens 12 can be directed to zoom in to the lower center of the image for instance. In this manner the device 10 includes an off center zoom feature 16 which is activated by the off center zoom activation button 18.

The electronic remote baby viewer 10 of the invention can further include a speaker/microphone 46 which is shown in FIG. 1.

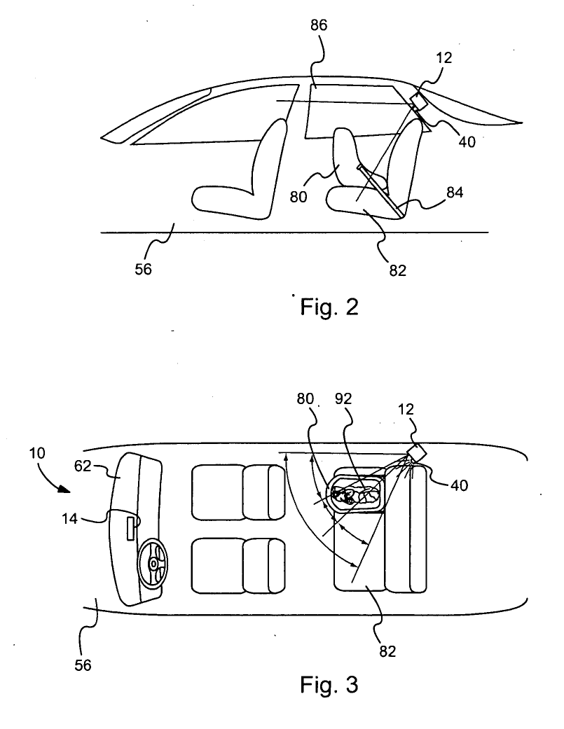

FIG. 2 shows an automobile mounted version of the invention. Shown in FIG. 2 is an infant car seat 80 mounted in a car seat 82, and secured by a seat belt 84. Mounted in a position adjacent to the infant car seat 80 is the digital camera lens unit 12, which can also include a light source 40. The light source 40 is available to illuminate the infant in darkened conditions without turning on the dome light of the automobile. Shown in FIG. 1 is also the automobile window 86 and the automobile 56.

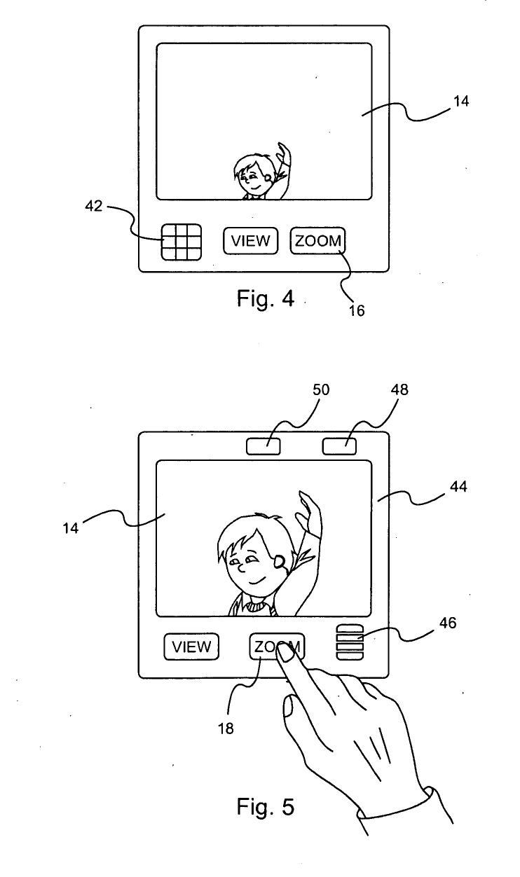

FIG. 3 shows the same automobile as FIG. 1 viewed from above. In this view the baby 92 is visible, and may be picked up by the digital camera lens unit 12. The image picked up is displayed on the digital viewing screen unit 14, which in this case is mounted on the dash board 62 of the automobile. FIG. 4 shows one possible configuration of the digital viewing screen unit 14, which includes a zoom point selection pad 42, or which could be configured with a touch screen zoom selection 44 as shown in FIG. 5. FIG. 4 shows that the object of interest in the view screen is in the lower center of the image displayed and FIG. 5 shows the camera zoomed into the lower center to better display the selected image. As shown in figure 5 a speaker/microphone 46 can be configured with the unit.

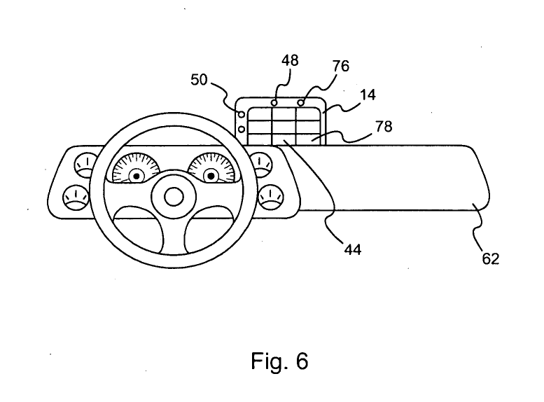

FIG. 6 shows the digital viewing screen unit 14 mounted on the dash board 62 of an automobile. The digital viewing screen unit 14 can include a touch screen 44 as shown, or can include a zoom point selection pad 42 as shown in FIG. 4. Shown in FIG. 6 is a magnification button 50, a brightness button 48, a camera selection button 76, which would choose between a number of cameras which are available

FIG. 3 is a perspective view of the electronic baby remote viewer 10 of the invention in which the pieces are assembled and the view screen 14 is visible.

The electronic baby remote viewer 10 of the invention also has the capability of zooming in on an object with a zoom feature which zooms to an off-center region of the screen. It is common in the prior art for an electronic viewing device to zoom straight forward and to magnify the portion of the screen which is in the center of the screen. This is generally a workable practice in Items such as cameras. However, in a viewer which is utilized in a door situation, it is more advantageous to zoom to an area that is not in the center of the view screen. This requires the use of a zoom point selection pad which can be in the form of a pad of buttons shown in FIG. 4, or can be in the form of a touch screen zoom selection such as shown in FIG. 44. By choosing the area to zoom towards, the view screen zooms, for instance, to the lower bottom of the screen, the lower left or right, the right side of the screen, the left side of the screen, or the center left or right upper part of the screen.

FIG. 4 shows an image of a person in the lower center of the view screen 14. When a selection is made on the zoom point selection pad 42 to zoom to the lower center of the screen, the view changes to that shown in FIG. 5. Shown in FIG. 4 is a view button 24 which activates the unit and a zoom button 16 which controls the amount of magnification of the image.

FIG. 5 also shows a magnification button 50, and a brightness button 48. The brightness button 48 can be tapped to increase the brightness of the image displayed. FIG. 6 also shows another preferred embodiment of the invention in which the digital view screen unit 14 is mounted on the dash board 62 of a car and includes a magnification button, a brightness button, and a camera selection button. The digital viewing screen 14 shown in FIG. 6 includes a touch screen zoom selection 44, in which different portions of the view screen may be touched with a person's finger in order to zoom into that portion of the view screen.

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. An electronic remote baby viewer, comprising:
a digital camera lens unit for mounting in a position adjacent to a region to be viewed, with said region to be viewed being a location where monitoring a child is desirable, with said region to be viewed remote from a user of said electronic remote baby viewer;
a digital viewing screen unit for mounting in a position at a selected distance from said digital camera lens unit, operationally connected to said digital camera lens unit, for convenient viewing of said region to be viewed by said user for the purpose of monitoring a child, with said digital viewing screen unit configured for use by a user in a room remote from the digital camera lens unit;
an off center zoom feature in which a selected region of view is magnified, in which the region magnified is a region other than the center of the image of said region to be viewed;
an off center zoom activation button; wherein
an image viewed in the digital viewing screen is magnified when said off center zoom activation button is depressed, and said image is magnified to show greater detail of a part of the image which is not the center of the image, for use in monitoring a child.

2. The electronic remote baby viewer of claim 1 in which said zoom feature is configured to magnify a region of said image located in the lower center of said image.

3. The electronic remote baby viewer of claim 1 in which said zoom feature is based on software magnification of said image.

4. The electronic remote baby viewer of claim 1 in which said zoom feature is configured to magnify a region of said image located in the lower right of said image.

5. The electronic remote baby viewer of claim 1 in which said zoom feature is configured to magnify a region of said image located in the lower left of said image.

6. The electronic remote baby viewer of claim 1 in which said zoom feature is configured to magnify one of a plurality of regions of said image, in which the region to be magnified is not the center of the image.

7. The electronic remote baby viewer of claim 6 in which said electronic remote baby viewer further comprises a zone selection button, for selecting a region of said image to magnify.

8. The electronic remote baby viewer of claim 6 in which said electronic remote baby viewer further comprises a zone selection button in the form of a touch screen, for selecting a region of said image to magnify.

9. The electronic remote baby viewer of claim 7 which further comprises a magnification button to change magnification to different levels of magnification.

10. The electronic remote baby viewer of claim 1 which further comprises a brightness button to change brightness of said image to different levels of brightness.

11. The electronic remote baby viewer of claim 1 which further includes a voice transmittal feature.

12. The electronic remote baby viewer of claim 1 which further includes a plurality of digital camera lens units placed at various locations around a residence, with said digital display unit further comprising a camera selection button or means to select which camera to display an image from on said monitor.

13. The electronic remote baby viewer of claim 12 which further comprises a selection means to select a region on each image of each camera for viewing, and a magnification means for magnification of the selected region of the selected image.

14. The electronic remote baby viewer of claim 12 which further comprises a magnification selection means for selecting different levels of magnification for the image selected from the various cameras.

15. The electronic remote baby viewer of claim 1 in which said digital camera lens unit is configured for placement in an automobile adjacent a baby in a rear facing car seat, for viewing said baby in said car seat, with said off center zoom function configured to magnify an image of said infant.

16. The electronic remote baby viewer of claim 1 which further includes a light source for illuminating a child being monitored.

17. The electronic remote baby viewer of claim 11 which further comprises a microphone attached to said digital camera lens unit, and a speaker with said digital display screen for transmitting sound from said baby to the display unit so that said user may listen to said baby.
